(19) United States
(12) Patent Application Publication
(10) Pub. No.: US 2023/0214743 A1
(43) Pub. Date: Jul. 6, 2023

(54) COMPUTER-BASED INTEGRATED, REAL TIME, DIGITAL, TECHNICAL PROCEDURE SCOPING, WRITING, MODIFYING, SCHEDULING, EXECUTING, AND MANAGING PLATFORM

(71) Applicant: RAMwright Consulting Co., LLC, GREENSBURG, PA (US)

(72) Inventor: Gary Josebeck, Greensburg, PA (US)

(21) Appl. No.: 18/083,036

(22) Filed: Dec. 16, 2022

Related U.S. Application Data
(60) Provisional application No. 63/290,397, filed on Dec. 16, 2021.

(51) Int. Cl. G06Q 10/0631

(52) U.S. Cl. CPC G06Q 10/06313; G06Q 10/0633

(57) ABSTRACT

A computer-based integrated, real time, digital, technical procedure platform includes a technical procedure scoping tool configured to assist in evaluating and defining a given operation or process; a technical procedure writing tool configured to assist in the drafting a written step by step technical procedure for a given operation or process; a technical procedure modifying tool configured for storing, revising, and updating technical procedures and maintaining a revision history of the technical procedure; a technical procedure scheduling tool configured for identifying the resources needed to complete a scheduled procedure, identifying a location of a scheduled procedure, setting a time for performing given scheduled technical procedures; a technical procedure executing tool configured to assist in performing a given technical procedure; and a technical procedure managing tool configured for monitoring and evaluating the progress and completion of technical procedures.

### RELATED APPLICATIONS

This application claims the benefit of U.S. Provisional Patent Application Ser. No. 63/290,397, filed Dec. 16, 2021, titled “Computer-Based Integrated, real time, digital, technical procedure scoping, writing, modifying, scheduling, execution and managing platform” which is incorporated herein by reference in its entirety.

### BACKGROUND OF THE INVENTION

### 1. Field of the Invention

The present invention relates to reliability engineering and to technical procedures.

### 2. Background Information

Reliability engineering refers to the systematic application of best engineering practices and techniques to operate a plant safely and efficiently such as to improve the overall equipment effectiveness by increasing the equipment availability, production rate, and product quality.

Technical procedures, and in some fields called Standard Operating Procedures (SOPs), represent important tools for consistently implementing best engineering practices and techniques. For example, written technical procedures are used extensively in the nuclear and general power generation industries, pharmaceutical and medical industries, food supply industries and chemical industries, to name a few, and some of these it is a regulatory requirement.

The Department of Energy standard DOE-STD-1029-92, Writers Guide for Technical Procedures, which is incorporated herein by reference, provides excellent background on the purpose, format and writing mechanics of preparing technical procedures. As discussed therein, a principal objective for technical procedures is that operations be conducted in a safe, deliberate, and controlled manner. In addition to training and day-to-day supervision, providing sound technical procedures and requiring workers to use them is among the most formal, direct, and effective methods available to facility managers to ensure that their operations meet designated objectives. Proper technical procedures provide managers with a critical management tool to communicate detailed expectations for how individual workers are to perform specific tasks.

When best implemented, technical procedures address how all operations and processes are to be performed, from the administrative to the technical, thus several broad types of technical procedures must be part of a facility's program including:

1. Management control procedures which define the communication and coordination activities necessary to carry out the facility's technical programs, management control programs, and design control programs. These procedures describe the processes to be followed to ensure that all of the various programs' functions are effectively integrated and that the programs' requirements are applied appropriately throughout the facility's lifetime.

2. Operational procedures which prescribe precisely how to accomplish the various technical tasks associated with starting up, testing, operating, and maintaining the facility's equipment and systems. These procedures specify fixed tasks and define activities in a way that ensures operations are safe, effective and standardized. It is noted that operational procedures are sometimes referenced as technical procedures in the art, but that would be confused with the broader use of the term technical procedure within the meaning of this application and is avoided herein.

3. Emergency and alarm response procedures which define the action steps to take when an abnormal condition exists. Emergency procedures address conditions that require immediate and absolute attention to mitigate problems, reestablish safety boundaries, and bring operations and equipment back within established operating parameters. Alarm response procedures address the actions to be performed in response to annunciators and other types of facility displays that indicate an abnormal condition. Each of these technical procedure types is slightly different owing to the intended purpose and use of the technical procedures; the considerations in effect at the time of use; the level of detail required to allow the task to be accomplished; the typical user of the procedure; and the degree to which compliance with the procedure must be documented.

The technical procedures that workers use, in order to be effective management tools, must present the best knowledge available of how to integrate the policies, principles, rules, parameters, processes, controls, products, culture, physical facilities, equipment, material, and people necessary to operate a facility safely. In addition, technical procedures must be technically and operationally accurate, up-to-date, and easy to follow, or workers will lack confidence in them and may not use them.

The background or supporting information, generally called basis documentation, must be organized and applied appropriately in developing a procedure for a specific process or technical procedure. Further, the resulting procedure must be accurate and easy to follow. Meeting these objectives requires the implementation of procedure programs that include, among others, the following program elements: The cooperation of management, technical, and administrative personnel in ensuring that sufficient staff time, information, and other resources are available to those individuals responsible for the procedures program. Further, procedures must be updated as required by operational activities: upgrades or modifications to equipment or systems may trigger procedural changes; adjustments in training requirements or certification levels may require reassessment of procedures; and changes in the safety requirements or management philosophy may also result in review of procedures to ensure that the procedures reflect the current configurations, philosophy, and safety criteria. Additionally, procedure revisions also result from growing operational sophistication; continued use of a procedure or the system or equipment it addresses may identify a better or more appropriate method for completing the task. Any change to the basis for facility operations will be likely to require procedure revisions.

Ensuring that a facility has adequate technical procedures that are maintained and updated, has been a complex job. In the food and drug industries inadequate technical procedures or standard operating procedures (SOPs) are one of the most frequently cited causes of many deficiencies and observations found in FDA initiated “Forms 483” and “Warning Letters”. While specific technical procedure issues can often be traced back to poor communication, monitoring, and/or enforcement, a poorly written technical procedure can quietly grow into a host of other major compliance problems. A well-crafted technical procedure offers clear direction and instruction specifically designed to avoid deviations—an absolute necessity for maintaining compliance and delivering quality products.

Depending on the size and scope of a company, a single organization may manage hundreds or even thousands of technical procedures. Any change in regulation, corporate policy, or production process can affect hundreds or thousands of personnel. This is where technical procedure “versioning” becomes critically important. For example, the FDA requires companies to distribute technical procedures in a timely manner and that each employee validate the receipt and understanding of it. In larger organizations, this often requires an expensive Electronic Data Management System (EDMS) that must comply with regulatory requirements, provide secure access for program monitoring and management, and store data in an audit-ready format that is quickly available for regulators during an inspection. “Failure to follow written procedures” appears frequently in Forms 483 and Warning Letters—a clear indication that employees neither understood nor applied the necessary knowledge to fulfill their responsibilities.

It has been recommended that technical procedure programs should include testing or evaluation features that establish an employee's level of comprehension for any technical procedure. Online-based testing programs have been proposed that give managers immediate access to this information and promote a quick response to knowledge gaps when identified. Similarly, testing documentation demonstrates to regulators that a company's commitment is to effective employee education rather than document distribution alone.

Digitizing technical procedures, sometimes referenced as computer-based procedures or CBP has been proposed for some time to phase out paper-based procedures. For reference, Brookhaven National Laboratory published “Computer-Based Procedure Systems: Technical Basis and Human Factors Review Guidance” in March 2000, which is incorporated herein by reference, and which studied human factor review guidance in Computer-Based Procedures in the nuclear industry.

INL published an “Evaluation of Computer-based Procedure System Prototype” in September 2012, (inl/ext-12-27155), which is incorporated herein by reference, that noted “Although CBPs have been investigated as a way to enhance operator performance on procedural tasks in the nuclear industry for almost 30 years, they currently are not widely deployed at United States utilities. Much of the previous research has focused on CBPs in the main control room for new plants with highly integrated systems. Adopting CBPs for older plants with less integrated systems poses many challenges that are not present in new plants. Additionally, CBPs for the main control room may be more challenging to implement than CBPs for field workers. Thus, the current research focuses on CBPs for field workers.”

In addition to generally discussing digitizing technical procedures this INL research project crafted a rudimentary procedure execution tool, a review of which is helpful in understanding the present invention.

The INL execution tool prototype included what they identified as “Context-sensitivity.” Allegedly, to minimize the risk of error and to make it easier for the field worker to take the correct action, the research team decided to incorporate context-sensitivity into the CBP. Context-sensitivity means that the CBP only presents the relevant steps to the user. In the prototype, relevant steps are selected based on user input.

The INL execution tool prototype included what they identified as “Simplified Step Logic.” A requirement identified by the research team states that when the necessary information is available to the CBP, the procedure system should evaluate the step logic. This allegedly shifts the burden of the evaluation to the system rather than the field worker. Thus, the researchers chose to revise the presentation of conditional steps. Instead of presenting the step as an IF/Then statement, the mock-up illustrates how the CBP would prompt the user to enter the relevant conditions (or acquire the conditions from a plant database), and then present the appropriate path.

The INL execution tool prototype included “Automatic Correct Component Verification.” Manipulating the wrong component was identified as one of the most common errors during procedure execution in the qualitative study. The CBP mockup illustrates how the CBP system should prompt the user to scan the barcode (or take a photograph of the label for optical character recognition) before proceeding with a step. The CBP system would verify that the scanned component was the correct component before allowing the operator to execute the step.

The INL execution tool prototype included Automatic Place Keeping.” Another common error that operators make during procedure execution is execution of steps out of sequence, or omitting a step. This has been attributed to the fact that place keeping in PBPs is difficult due to the lack of salience in the place keeping method. The mock-up illustrates how the CBP system keeps track of where the field worker is in the procedure, marks steps as completed, and highlights the currently active step. The CBP mock-up also illustrates how the operator can quickly navigate to the currently active step from anywhere in the procedure interface by clicking on a continuously available link to the active step. Additionally, the mock-up illustrates how the CBP system should prevent the operator from executing any step other than the currently active one.

The INL researchers found that presenting a procedure on a small device such as an IPAD® tablet computer poses many challenges, and the researchers decided to present the procedure one step at a time. The researcher assert it is essential that the CBP system allows the field worker to look ahead and back in the procedure as well as finding where in the procedure the field worker is at all times. The prototype allows the user to navigate to any step in the procedure from any place in the procedure. As an alternative to the single-step presentation style, the researchers developed an overview mode, which displays all of the steps so that a user can continuously scroll through the entire procedure. In several situations, the user may want additional information including: information regarding how they ended up in a particular path, information about how to actually use the procedure system, information, etc. The prototype shows that additional information will be indicated with a small icon. The prototype highlights the critical information that a user needs to accomplish his task. Steps that are not yet activated, are “grayed out” making them readable, but indicating that they are disabled. The INL research demonstrates the needs for these tools.

Visual Knowledge Share Ltd. promotes a Digital Work Instruction Platform in which procedures and documentation are digital for easier use, better understanding, and quicker updates. Made of photos, videos, audio recordings, charts, plans, and the like, the digital instructions are intended to yield less confusion and higher quality results in a paperless, data processing tool that gathers real-time information for improved control of operations. The Digital Work Instruction Platform represents some of the commercially available platforms available, yet they do not integrate necessary components into the overall system.

There still remains a need for effective tools for technical procedure scoping, technical procedure writing, technical procedure modifying, technical procedure scheduling, technical procedure executing, and technical procedure managing.

### SUMMARY OF THE INVENTION

One aspect of the invention provides an integrated, real time, digital, technical procedure platform comprising: a technical procedure scoping tool configured to assist in the process of evaluating and defining a given operation or process including an assembly or listing of required tools, equipment, parts, labor, authorizations, images, and existing hazards and all other constituents necessary for writing a technical procedure therefor; a technical procedure writing tool configured to assist in the process of drafting a written step by step technical procedure for a given operation or process; a technical procedure modifying tool configured for storing, revising, and updating technical procedures associated with changes to the procedures and/or constituents thereof, and maintaining a revision history of the technical procedure; a technical procedure scheduling tool configured for identifying the resources needed to complete a scheduled procedure, identifying a location of a scheduled procedure, setting a time for performing given scheduled technical procedures, including beginning times and estimated end times; a technical procedure executing tool configured to assist in the process of performing a given technical procedure; and a technical procedure managing tool configured for monitoring and evaluating the progress and completion of technical procedures.

One aspect of the present invention provides an integrated, real time, digital, technical procedure writing platform including common libraries for at least three of parts, tools, equipment, labor, hold codes, delay codes, hazards and permits.

One aspect of the present invention provides an integrated, real time, digital, technical procedure scoping and writing platform including a scoping tool configured to allow writers to evaluate and define a given operation or process including an assembly or listing of required tools, equipment, parts, labor, authorizations, images, and existing hazards and all other constituents necessary for writing a technical procedure therefor in a writing tool of the platform.

These and other advantages of the present invention will be clarified in the brief description of the preferred embodiment taken together with the drawings.

### DESCRIPTION OF THE FIGURES

FIG. 1 is a navigation page to various segments or aspects of the integrated, real time, digital, technical procedure scoping, writing, modifying, scheduling, executing, and managing platform according to the present invention.

FIG. 2 illustrates an administration segment account information page which is part of the managing tool of the platform of the present invention.

FIG. 3 illustrates a login screen of the managing tool for the platform of the present invention.

FIG. 4 illustrates an administration segment user information page of the managing tool which is associated with the platform of the present invention.

FIG. 5 shows an administrative location for adding to a parts library which is associated with the platform of the present invention.

FIG. 6 shows an administrative location for adding to a tools library which is associated with the platform of the present invention.

FIG. 7 shows an administrative location for adding to an equipment library which is associated with the platform of the present invention.

FIG. 8 shows an administrative location for adding to the labor library which is associated with the platform of the present invention.

FIG. 9 shows an administrative location for adding to the standardized hold code library which is associated with the platform of the present invention.

FIG. 10 shows an administrative location for adding to the standardized delay code library which is associated with the platform of the present invention.

FIG. 11 shows an administrative location for adding to the standardized hazard code library which is associated with the platform of the present invention.

FIG. 12 shows an administrative location for adding figures, tables, videos and the like into an attachment library of uploaded figures and videos that can be used within the procedures associated with the platform of the present invention.

FIG. 13 shows a scoping tool implemented in the platform of the present invention.

FIG. 14 shows a cover page portion of the writing tool for writing procedures in the platform of the present invention.

FIG. 15 shows an introduction portion of the writing tool for the inputs for the introduction stage of the writing of procedures on the platform of the present invention.

FIG. 16 shows a precautions and limitations segment of the writing tool of the writing of procedures on the platform of the invention.

FIG. 17 shows a prerequisite section of the writing tool 30 for writing of procedures on the platform of the invention.

FIG. 18 shows the specifics of one instruction in the writing tool 30 for writing of procedures on the platform of the invention.

FIG. 19 shows the inputs for custom data entry tables associated with the software's ability to generate custom data entry tables and store them for use in other procedures on the platform of the invention.

FIG. 20 schematically illustrates a scheduling tool of the platform of the present invention.

FIG. 21 schematically shows a PERT chart created by the platform of the present invention for a representative procedure on the platform of the invention.

FIG. 22 schematically illustrates a real time updated schedule of procedures shown in the platform of the present invention.

FIG. 23 schematically illustrates a subway chart associated with a given procedure formed by the platform of the present invention.

FIG. 24 schematically illustrates some of the management aspects in the managing tool of the platform of the present invention for monitoring and evaluating the progress and completion of technical procedures.

FIG. 25 schematically illustrates some of the management aspects in the managing tool of the platform of the present invention.

FIG. 26 schematically represents a cover page in an execution tool for technical procedures with the platform of the invention.

FIG. 27 schematically illustrates an introduction section in an execution tool for technical procedures with the platform of the invention.

FIG. 28 schematically illustrates a precautions and limitations sections in an execution tool for technical procedures with the platform of the invention.

FIG. 29 schematically illustrates a prerequisites portion of in an execution tool for technical procedures with the platform of the invention..

FIG. 30 schematically illustrates a performance section or execution section of the platform where the operater is shown the relevent steps of a procedure.

FIG. 31 schematically illustrates another performance section or execution section of the platform where the operater is given a procedure that has an IF-THEN alternative path procedure.

FIG. 32 schematically illustrates an opened tool box of the platform allowing the operator to add to or access aspects of a procedure in the platform of the invention.

### DESCRIPTION OF THE PREFERRED EMBODIMENTS

It is an object of the present invention to provide an effective and efficient computer-based, integrated, real time, digital, technical procedure scoping, writing, modifying, scheduling, executing, and managing platform. The platform may be “cloud-based”, or a SaaS platform in its implementation.

The phrase “technical procedure” within the meaning of this application defines a written step by step operational procedure on how a given operation or process is to be performed, from the administrative to the technical to emergency. Generally, these would follow the guidelines set forth in DOE-STD-1029-92 Writers Guide for Technical Procedures.

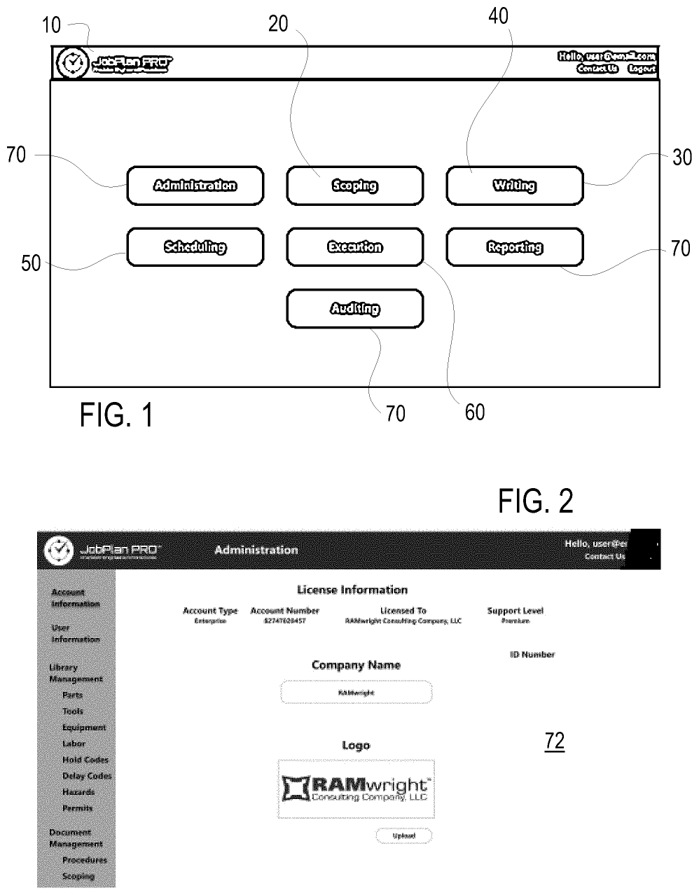

FIG. 1 is a navigation page 10 to various segments or aspects of the platform of the present invention which, as discussed in detail below, provides an effective and efficient integrated, real time, digital, technical procedure scoping 20, writing 30, modifying 40, scheduling 50, executing 60, and managing 70 platform. The operation of each of these segments of the invention will be discussed in detail below. Some users will have limited access to various segments of the platform that are associated with what they need and with which are authorized to view and interact.

The phrase “technical procedure scoping” within the meaning of this application defines the process of evaluating and defining a given operation or process including an assembly or listing of required tools, equipment, parts, labor, authorizations, images, and existing hazards and all other constituents necessary for writing a technical procedure therefor. The technical procedure scoping 20 aspects of the platform are accessed with the scoping button or icon.

The phrase “technical procedure writing” within the meaning of this application defines the process of drafting a written step by step technical procedure for a given operation or process. Written means fixed in tangible reproducible form, which in this implementation is digital. The technical procedure writing 30 aspects of the platform are accessed with the writing button or icon.

The phrase “technical procedure modifying” within the meaning of this application defines the process of storing, revising, and updating technical procedures associated with changes to the procedures and/or constituents thereof, and maintaining a revision history of the technical procedure. The technical procedure modifying 40 aspects of the platform are also accessed with the writing button or icon.

In one implementation of the platform of the invention, all storage is cloud-based and available on any approved device. In a SaaS model, the platform will hold a client's procedures for a period of service (and even longer) in order to allow for retrieval for investigative or federal inspection purposes.

The phrase “technical procedure scheduling” within the meaning of this application defines the process of identifying the resources needed to complete a procedure, location of procedure setting a time for performing given technical procedures, including beginning times and estimated end times. The integrated platform of the present invention provides accurate real time estimates of procedure and schedule completions. The technical procedure scheduling 50 aspects of the platform are accessed with the scheduling button or icon.

The phrase “technical procedure executing” within the meaning of this application defines the process of performing a given technical procedure. The technical procedure executing 60 aspects of the platform are accessed with the executing button or icon.

The phrase “technical procedure managing” within the meaning of this application defines the process of monitoring and evaluating the progress and completion of technical procedures. The technical procedure managing 70 aspects of the platform are accessed primarily with the reporting button or icon, although the auditing and administrative icons will lead to monitoring and evaluation aspects as well.

The term “integrated” within the meaning of this application in relation to the technical procedure scoping tool 20, the technical procedure writing tool 30, the technical procedure modifying tool 40, the technical procedure scheduling tool 50, the technical procedure executing tool 60, and the technical procedure managing tool 70 of the platform refers to the interaction of each of these tools on the platform.

FIG. 2 illustrates an administration segment account information page 72 (which is part of the managing tool 70) associated with the platform of the present invention. The platform of the present invention allows individual users or licensees to incorporate and upload corporate identities and logos into their procedures managed by the platform as shown in FIG. 2. Updating logos and corporate names on each of the procedures being managed by the platform can be critical in situations in which the company has had a name change, a merger and acquisition or a branding logo change.

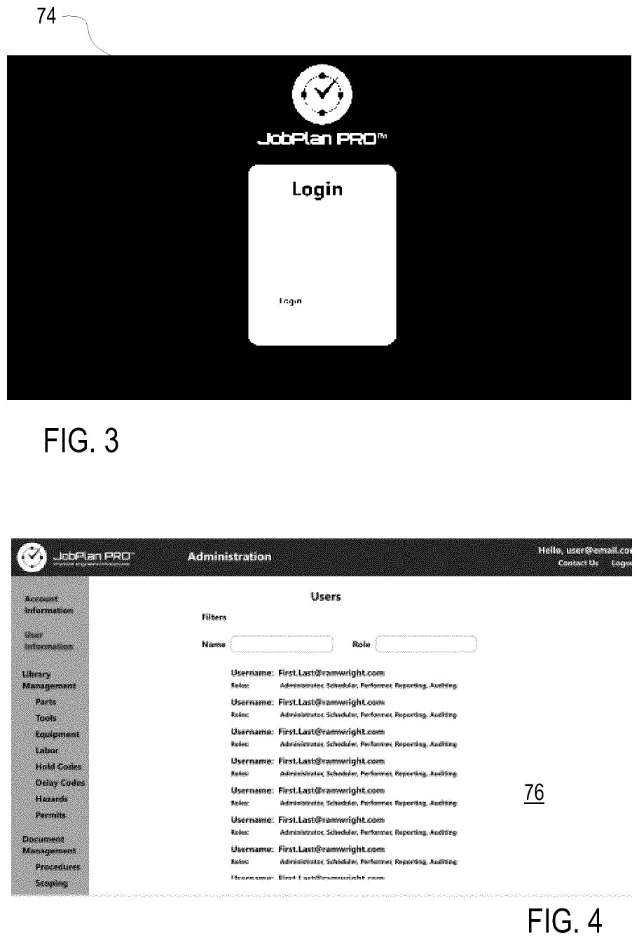

FIG. 3 is a login screen 74 of the managing tool 70 for the platform of the present invention. The login of specific users can include password protection and higher authentication access authentication (not shown). The platform will track who is creating and/or updating procedures as well as when such material is added and, of course the material itself.

FIG. 4 illustrates an administration segment user information page 76 of the managing tool 70 which is associated with the platform of the present invention. Some users will have limited access to various segments of the platform that are associated with what they need and with which they are authorized to view and interact. The administrator can define roles that define a level of access for each user.

Libraries 80

One key aspect of the platform of the present invention is to provide common libraries 80 of parts, tools, equipment, labor, hold codes, delay codes, hazards and permits. These libraries 80 are used by the procedure writers to pull from when developing the procedures. Having a common set of parts, tools, equipment, labor, hold codes, delay codes, hazards and permits allows for uniformity in the procedures. Further as a parts, tools, equipment, labor, hold codes, delay codes, hazards and permit in one such library 80 is updated or replaced the platform can automatically update all procedures with that updated or replaced component.

In addition to the libraries 80 listed is a library 80 of uploaded figures and videos that can be used within the procedures. The figures may be interconnected or linked with associated components from the parts, tools, equipment, or other libraries. For example the video may be a short film showing a 360 view of a piece of equipment in operation that the writers of a procedure can insert in select procedures using that piece of equipment and the video is linked with the equipment listing in the library 80 for easy access. The figure and video library 80, like the other separate libraries 80, gives the ability to locate all references of a figure or video used in any procedure across the platform and can push a new/updated replacement image or video to any procedure using an old image/video that is updated. The platform will record and document any such updating.

Many facilities will implement a computerized maintenance management system or CMMS system. The platform will integrate with a facility's CMMS system to add or remove parts, equipment and other library 80 information with API calls, whereby if the user updates their CMMS system, the platform can automatically update the associated procedures. The platform will track and document any such updates. The platform will also integrate with the CMMS to input Start and Finish times on any Work Orders generated by the CMMS and referenced within Schedule Tool of the platform.

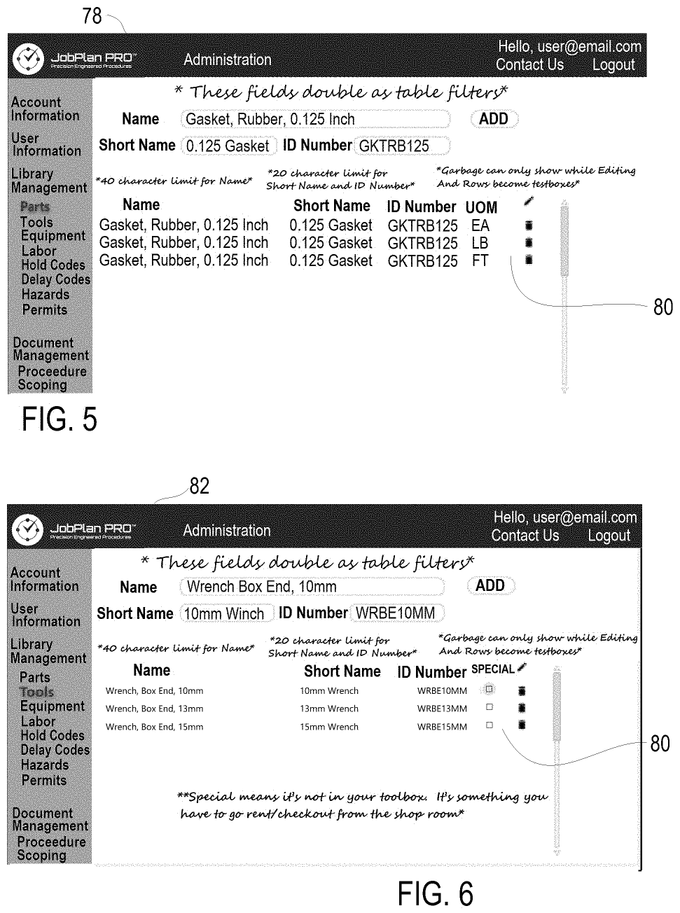

FIG. 5 shows the administrative location 78 for adding to the parts library 80 and it can be seen that each part has a name, a short name and ID number. The name may include a genus species designation to help sort and organize the parts listing. It is anticipated that select administrative users will be able to add to the libraries 80. The parts in the parts library 80 should reflect those the facility typically has on hand and the platform will interact with an inventory of parts to advise when parts in a given selected procedure desired for scheduling are not in inventory.

FIG. 6 shows the administrative location 82 for adding to the tools library 80 and it can be seen that each tool, like the parts, has a name, a short name and ID number. The name may include a genus species designation to help sort and organize the tool listing. The tools in the tools library 80 should reflect those the facility has on hand and the platform will interact with an inventory of tools to advise when tools in a given selected procedure desired for scheduling are not in inventory, or unavailable due to other ongoing procedures. Specific tools may further be linked to specialized labor, although generally such restrictions are associated with what is considered equipment.

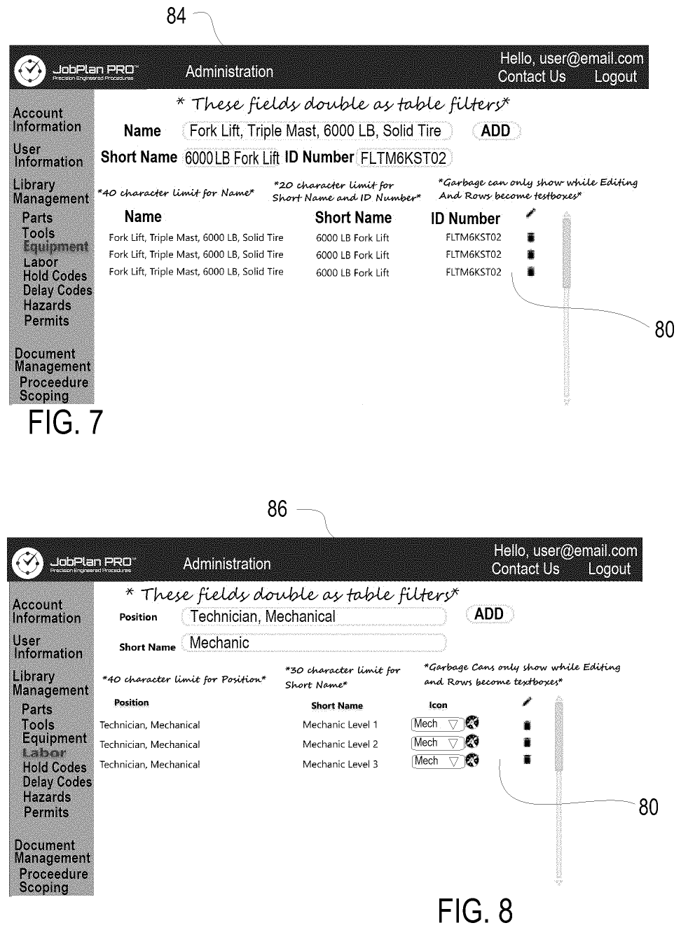

FIG. 7 shows the administrative location 84 for adding to the equipment library 80 and it can be seen that each equipment component, like the parts, has a name, a short name and ID number. The name may include a genus species designation to help sort and organize the equipment listing. The equipment in the equipment library 80 should reflect those the facility has on hand. Specific equipment may further be linked to specialized labor/equipment operators. The platform will interact with an inventory of equipment to advise when equipment in a given selected procedure desired for scheduling are not in inventory, or unavailable due to other ongoing procedures or lack of qualified equipment operators on site.

FIG. 8 shows the administrative location 86 for adding to the labor library 80 and it can be seen that each labor component has a position title and a short name and icon associated therewith. The labor components represent defined positions (e.g., mechanical technician, electrical technician) rather than a listing of individual employees. Specific labor positions will be associated with certain skill sets and certifications and administrative allowances.

The platform will interact with onsite employee management systems to match up the labor positions of scheduled and executed procedures with onsite employees. The use of standardized positions within the labor library 80 facilitate this operation.

For example, employee badges are often used to swipe an employee into the facility and the platform can integrate with this badge-based system to advise if the labor or management associated with a procedure in question is available, or alternatively advise if there is a lack of qualified labor (such as needed equipment operators) or managers on site. Further in execution the platform will not allow procedures to progress unless the correct labor is available or logged in, although the system will allow a supervisor with correct authority to override this stopping of a procedure due to lack of qualified labor and the override will be properly documented.

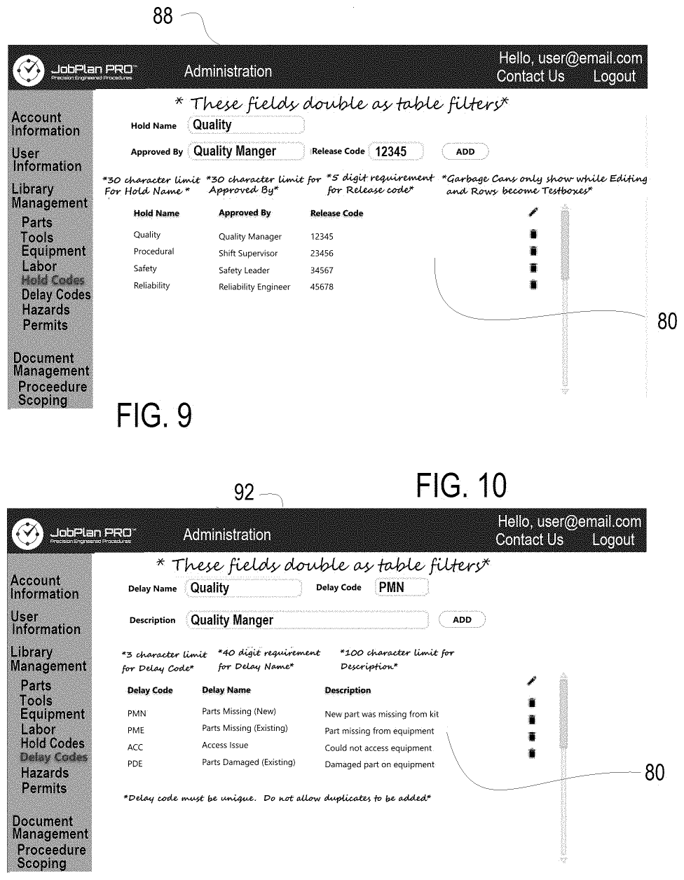

FIG. 9 shows the administrative location 88 for adding to the standardized hold code library 80. Hold codes define procedure review and approval steps and are used to insert safety, review, and supervisory authentication within the execution of a procedure. The hold library 80 uses a hold name for each hold together with the identity of the person who approves this designated hold and a code the designated hold authorizing agent inputs at that point in the protocol. For example a “safety” hold requires approval or authorization from a safety leader. The approval or authorization will be by a suitable “safety leader” that is signed into the system entering the proper code at this time or point in the procedure. The platform will record who and when each hold was released in the implementation of a procedure. The hold code library 80 allows for uniformity in hold designations. Further, a single employee could qualify to release several holds, for example a reliability engineer may also be a safety leader.

FIG. 10 shows the administrative location 92 for adding to the standardized delay code library 80. Delay codes define standardized delay descriptions to be entered into an executed procedure on the platform as delays are encountered in executing procedures. Standardized delay codes are a key component in the administrative review and management of executed procedures on the system. Allowing users to always free form enter delays into an executed procedure can lead to common recurring delays from being overlooked and thus not timely addressed. In a similar fashion, entering two overlapping or duplicate delay codes into the delay code library 80 can also hinder the review and management process.

FIG. 11 shows the administrative location 94 for adding to the standardized hazard code library 80. The hazards and permits libraries 80 operate similar to the libraries 80 discussed above. Hazards will be a standardized listing of hazards the users must be aware of in preforming a procedure, such as Electrical or Chemical. The permits library 80 also is a standardized library of procedure elements, in this case environmental notices such as Hot Work or Confined Space. Having an updatable standardized library 80 of these elements creates a more uniform system of procedures and allows for updating of all procedures across the platform when a standardized hazard or permit description is updated.

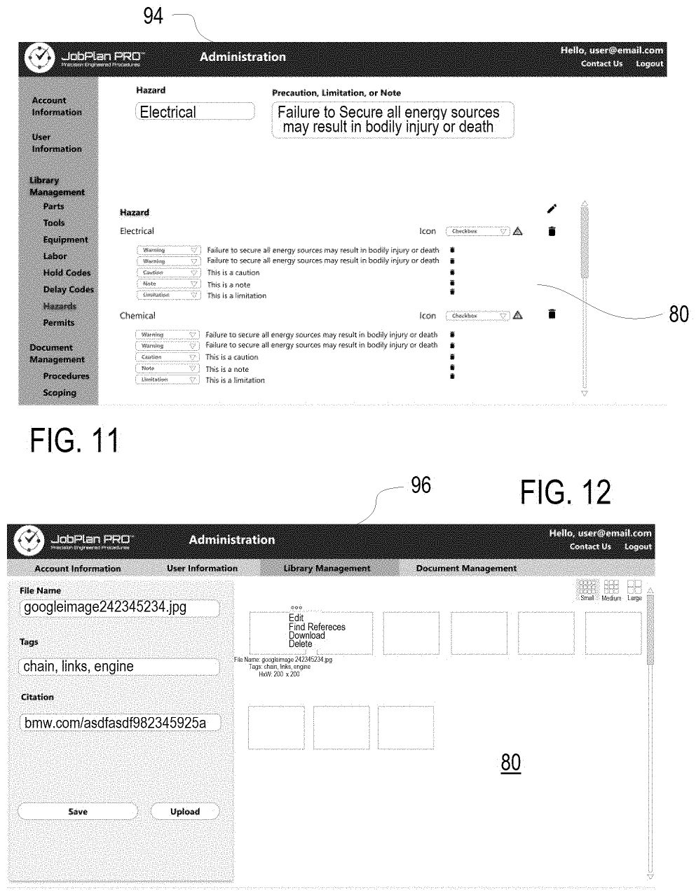

FIG. 12 shows the administrative location 96 for adding figures, tables, videos and the like into an attachment library 80 of uploaded figures and videos that can be used within the procedures. The files in this library 80 may be interconnected or linked with associated components from the parts, tools, equipment, or other libraries 80 via tags entered here.

Scoping 20

One aspect of the present invention is the ability of procedure writers to use the scoping tool 20 to define the process of evaluating and defining a given operation or process including an assembly or listing of required tools, equipment, parts, labor, authorizations, images, and existing hazards and all other constituents necessary for writing a technical procedure therefor. The writers may collect new video and audio and photos in the field associated with a new procedure to be written. There may be notes on new components needed for an associated new procedure, new parts, new tools, new equipment and the like.

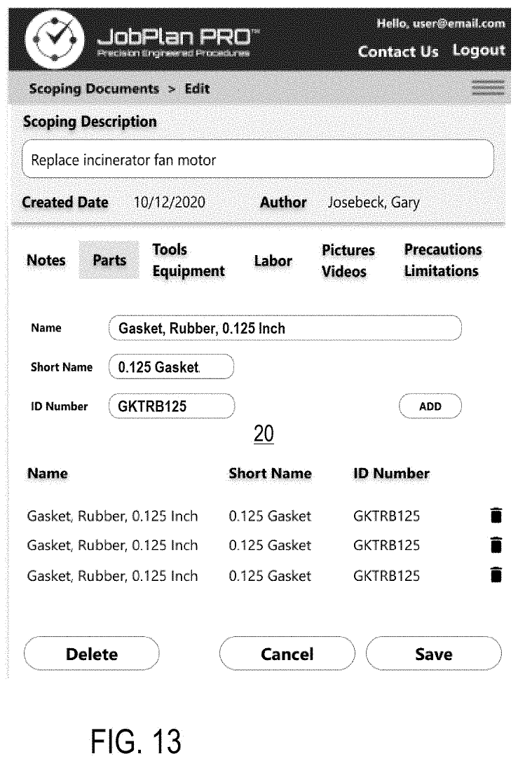

FIG. 13 shows a scoping tool 20 implemented in the platform of the present invention. Tools, equipment, parts, labor, precautions, holds and figures can be pulled from an appropriate library 80 and under the proper heading, with a running parts list as schematically shown in FIG. 13. Additionally, new components in each category not in the libraries 80 can be added as the project or potential procedure is being planned out. Notes, pictures audio, video can all be added in the scoping 20 workspace associated with the proposed procedure. The new components are not added into a library 80 from here but obviously may be added by administrators later. Scoping is done in the field and saved for later when the Writer can sit in the office and write out with greater detail. A separate scoping document or collection formed by the scoping tool 20 greatly facilitates writing of the specific procedures.

Writing 30/Modifying 40

FIG. 14 shows a cover page portion 32 of the writing tool 30 for writing procedures in the platform of the present invention. The the writing tool 30 the procedures to be prepared are divided up into the following sections: Cover Page, Introduction, Table of Contents, Revisions, Precautions & Limitations, Prerequisites, Performance, and Post-Performance.

The writing tool 30 essentially also forms the modifying tool 40 for existing procedures on the platform. Modification of a procedure may include a separate scoping document associated with the modification in question. The technical procedure modifying tool 40 is configured for storing, revising, and updating technical procedures associated with changes to the procedures and/or constituents thereof. The modification tool 40 will also maintain a complete revision history of the technical procedure. Note that any portion of a procedure created in tool 30 may be modified in tool 40 after the procedure has been created.

The cover page 32 originally created in tool 30 will include a short title, date, catagorization of the level of use of the procedure, a body or abstract of the procedure and bibliographic information related to the procedure.

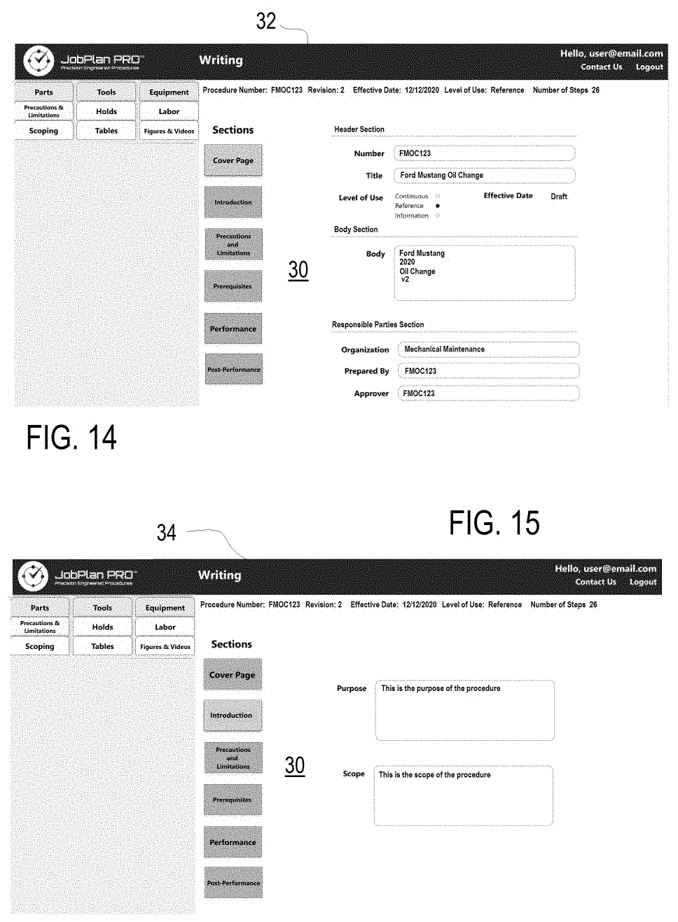

FIG. 15 is showing an introduction portion 34 of the writing tool 30 showing the inputs for the introduction stage of the writing of procedures on the platform of the invention. Specifically the writer states the purpose of the procedure and the scope of the procedure. The writer will have access to the scoping document from the scoping tool 20 here to facilitate pulling material from that workspace into the procedure prepared in the writing tool 30. Thus in the platform of the invention when in the writing section 30 the writer has ready access to the scoping document in the scoping tool 20 associated with the procedure being written with everything prepared for easy inclusion into the new procedure. The scoping document will likely be drafted by the writer of the procedure. The scoping process 20 and associated document on the platform not only organizes the data, it makes it available for retrieval into the writing section 30 for faster access and inclusion.

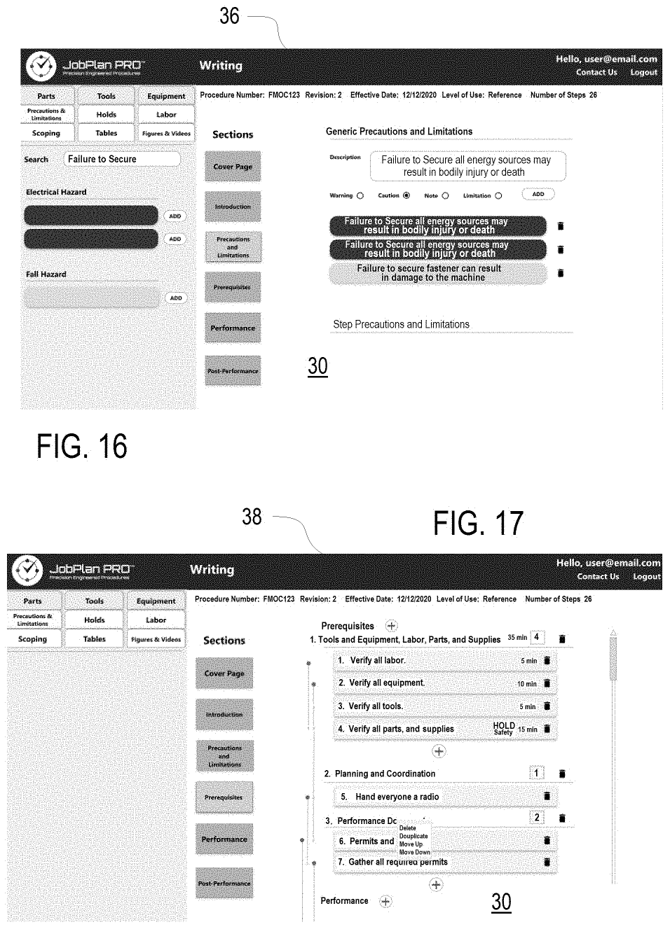

FIG. 16 is showing the precautions and limitations segment 36 of the writing tool 30 for the writing of procedures on the platform of the invention. Here the user pulls from the relevant libraries 80 to insert the appropriate pre-configured precautions and limitations. The scoping document from tool 20 can be easily referenced here to identify relevant components from the relevant library 80 and possibly see if new components need to be added to the libraries 80.

FIG. 17 is showing the prerequisite section 38 of the writing tool 30 for writing of procedures on the platform of the invention. The prerequisites are subdivided into a verification of components, planning and coordination and perfomance documents sections. The user outlines each step of the procedure in short clear instructions. Each step will have a time associated therewith. Note that a safety based hold was added for surpervisory overview and the beginning stages of this procedure. The platform will number all the steps, track and total the times of the steps, as well as keep totals of parts, tools, equipment, and labor needed for the procedure. Based upon what tools, equipment, parts, etc. are used on each step, the platform of the invention will calculate the total requirements for the job or procedure and can also show “when” the equipment, specialized labor and/or tools are needed to efficiently schedule their use among other workers on other jobs/procedures.

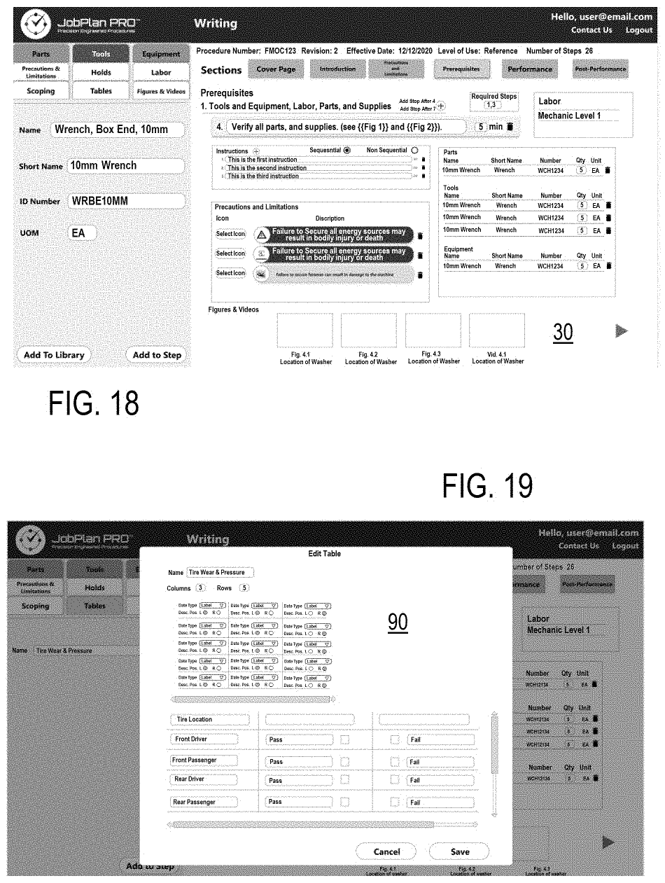

FIG. 18 shows the specifics of one instruction in the writing tool 30 (#4 in this illustrative example) and shows that the details of this instruction can include separate substep instructions (sequential or nonsequental), precaustions/limitations, parts listing, tools listing, equipment listing, labor listing (as needed) and desired figures and videos. As parts, tools, equipment, labor, or the like is added to a given step, the platform keeps a running total of all of these elements for the entire procedure.

FIG. 19 shows the inputs for custom data entry tables 90 and shows software's ability to generate custom data entry tables 90 and store them for use in other procedures. These tables 90 can be integrated to a company's EAM software to generate follow-up work orders if limits are exceeded and repairs are required.

Scheduling 50

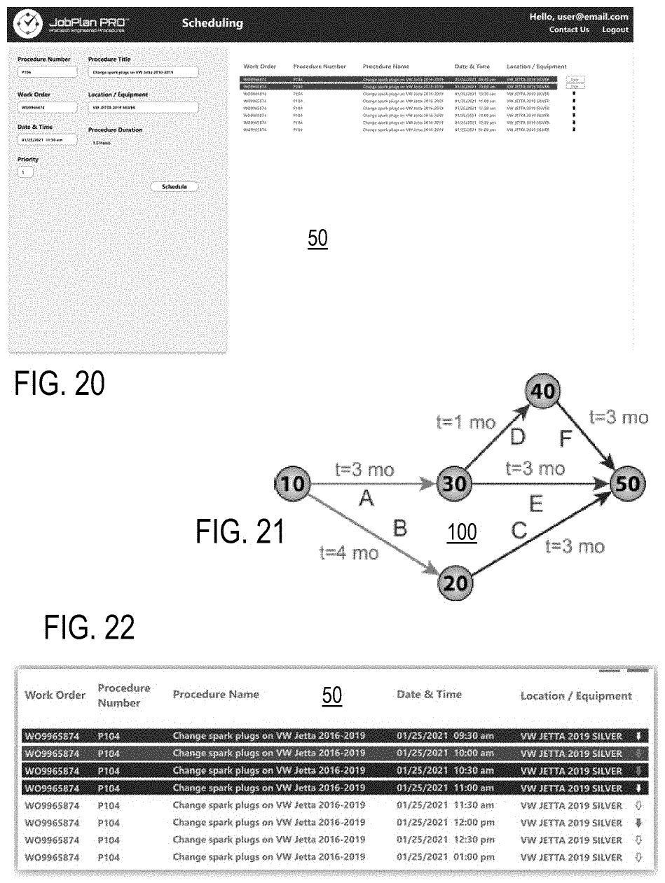

FIG. 20 schematically illustrates a scheduling component or tool 50 of the platform of the present invention. The platform provides that with the scheduling of the desired procedures the platform will identify the resources needed to complete each procedure, will identify the location of each procedure, will set a time for performing given technical procedures, including beginning times and estimated end times. The scheduled jobs may be color coded, such as being shown in red if there is an issue with the scheduling. For example, the platform could indicate that a specific resource needed to complete the job is unavailable (a gasket is not in stock, a piece of equipment is unavailable, suitable labor or administrative personal is not present, and the procedure desired to be scheduled would be listed in red (or other indication). Clicking on a procedure would detail any such deficiencies.

A PERT chart is a visual project management tool used to map out and track the tasks and timelines. The name PERT is an acronym for Project (or Program) Evaluation and Review Technique. A PERT chart can be drawn as a free-form diagram. PERT charts conventionally include boxes or circles (“nodes”) representing events or milestones and connecting them via arrows, representing the tasks that must be completed between each milestone and the amount of time the team will have to complete each task. The platform of the present invention automatically creates PERT charts 100 for the overall procedure and for steps. FIG. 21 schematically shows a color coded PERT chart 100 created by the platform of the invention for a representative procedure showing steps 10, 20, 30, 40 and 50 with the time between the steps. In a procedure, the PERT chart(s) will be color coded indicating progress.

FIG. 22 schematically illustrates a real time updated schedule of procedures shown in the scheduling tool 50 of the platform of the present invention. The jobs of a schedule are shown and color coded with red being jobs that are late, green being jobs that are completed, blue are on time and white are not started. The arrow on the far right side that is pointing down indicates whether or not the procedure has been downloaded from the cloud for use “offline” or to speed up the time to view high resolution images. Clicking on any job in the scheduling tool 50 can give further details including the PERT chart(s) 100 and/or Subway chart 110 associated therewith.

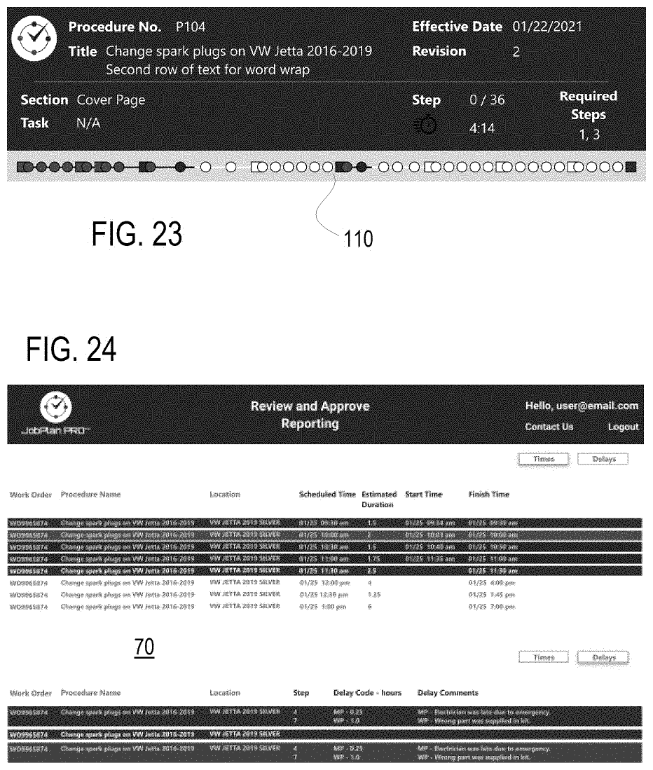

FIG. 23 schematically illustrates a subway chart 110, generally in color, associated with a given procedure formed by the platform of the present invention. The subway chart 110 is a linear chart showing each of the steps of a given procedure along a continuous line (like the illustrations of the stops on a subway map). The subway chart 110 will preferably be color coded similar to that above, with green steps completed, blue on time white not started, and red late. As there typically are a large number of steps in a given procedure the subway chart 110 will be dynamically displayed to compact the jobs already completed and the jobs to be started in a minimized overlapped fashion and spread out the jobs around where the procedure is at currently. As several steps may be performed concurrently there may be several “spaced apart” sections of the subway chart 110.

Managing 70

FIG. 24 illustrates some of the management aspects in the managing tool 70 of the platform of the present invention which allows for technical procedure managing in the form of monitoring and evaluating the progress and completion of technical procedures. The technical procedure managing tool 70 and associated aspects of the platform are accessed primarily with the reporting button or icon and can generate a report schematically shown in FIG. 24, although the auditing and administrative icons will lead to portions of the managing tool 70 for monitoring and evaluation aspects as well.

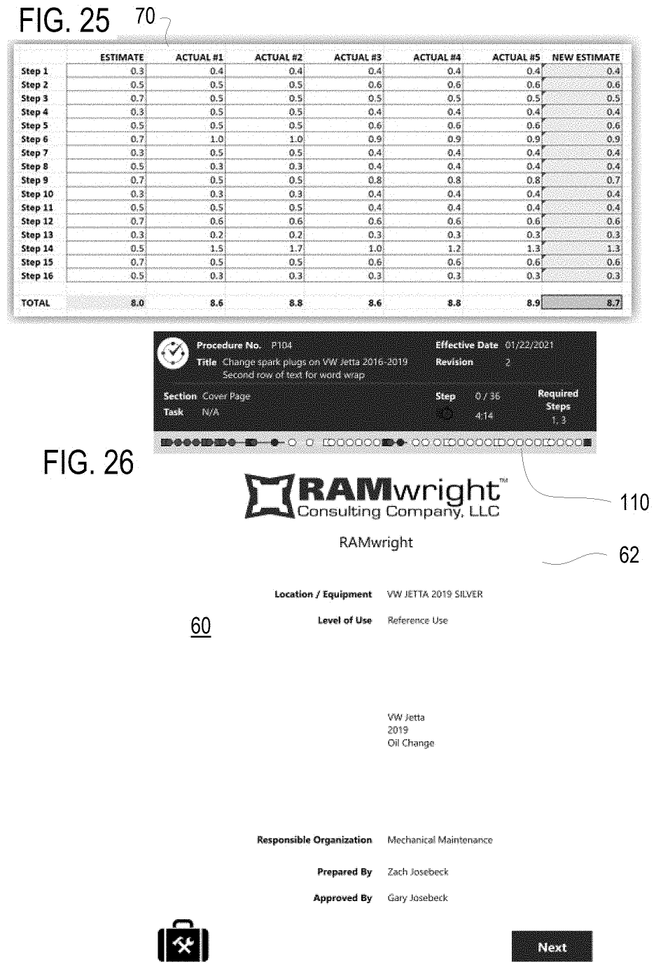

FIG. 25 illustrates some of the management aspects of the managing tool 70 of the platform of the present invention in which the platform of the invention can update the individual step and total job or procedure durations of the procedures on the system based upon statistical analysis of past performance.

Execution 60

FIG. 26 schematically represents a cover page 62 of the execution tool 60 for technical procedure executing with the platform of the invention. Execution refers to the process of performing a given technical procedure which is on the platform. The application will describe a single operator performing the procedure for simplicity, but in practice a number of operators (and supervisors) may be involved in executing and performing a procedure. The cover page 62 will be the first page the operator sees when executing a procedure in the executing tool 60. The platform formats the procedures with tool 60 for desktops, tablet, smartphones and the like and the platform allows the procedures to be performed on line, as well as downloaded and performed offline. The on-line performance or execution of a procedure allows real time update of the progress of the procedure and of the entire schedule. Offline execution of a procedure will update the schedule when the operator uploads the completed procedure. It is possible that only select tasks of a procedure are performed offline while others are performed online.

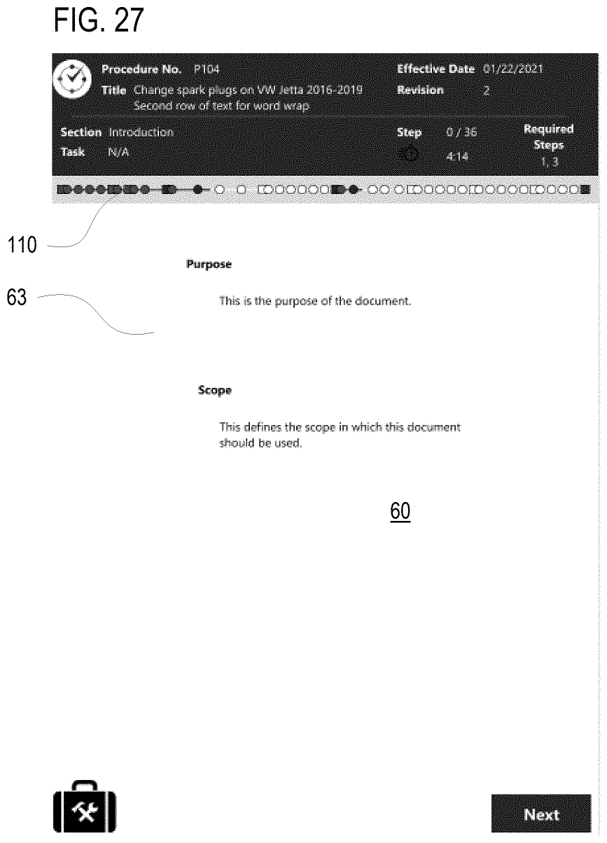

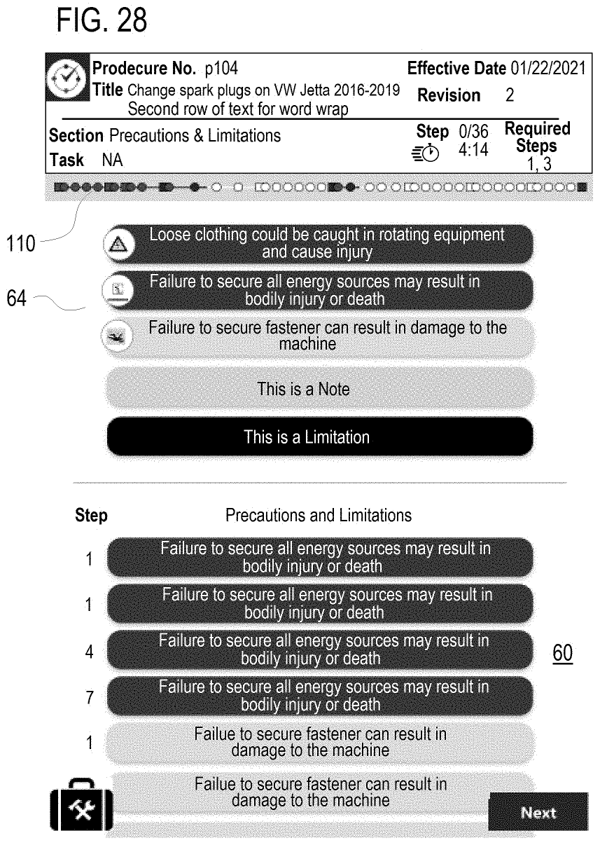

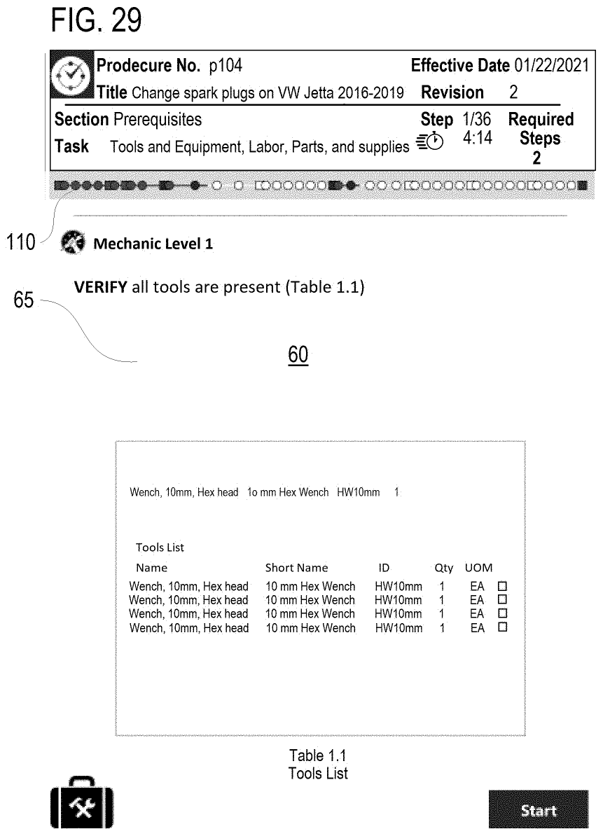

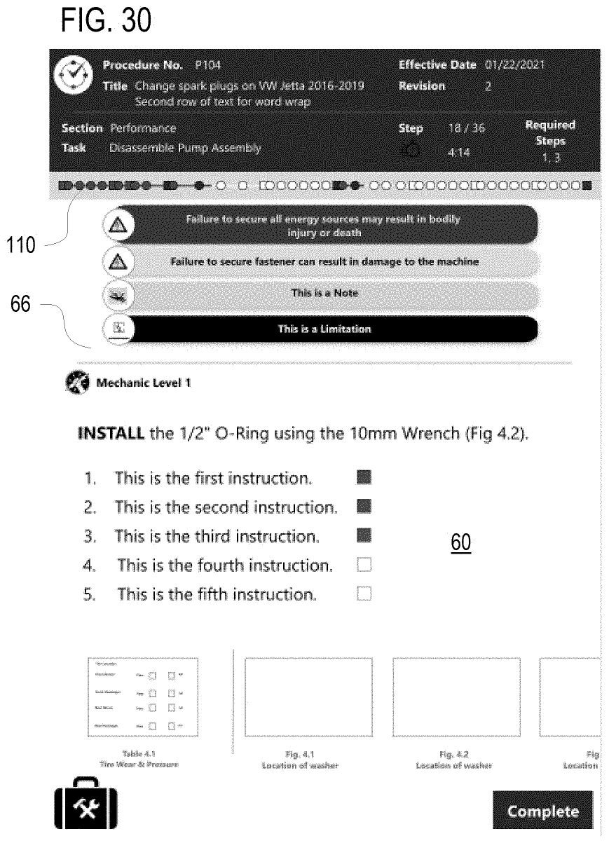

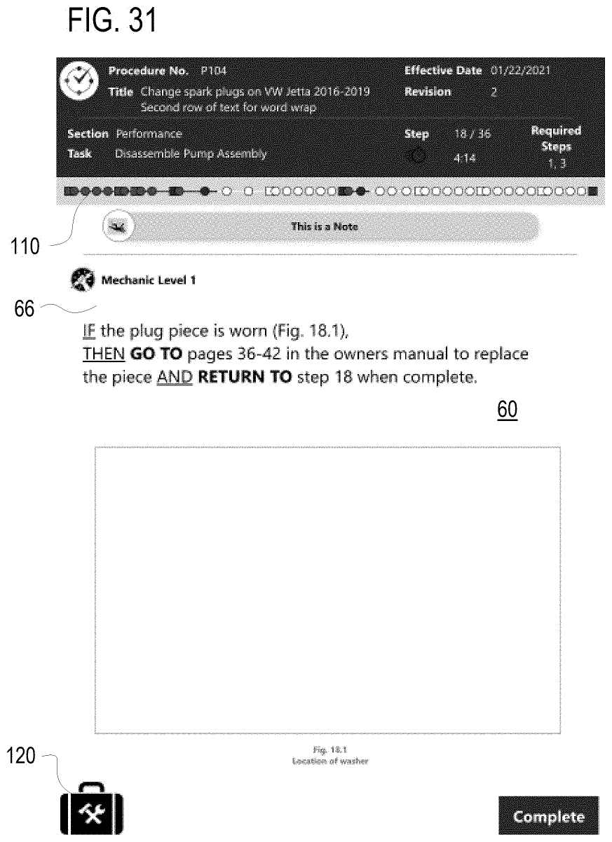

The procedure executed in tool 60 can be divided into a i) a cover page or section 62 as shown in FIG. 26; ii) a revision section which is only bibliographic in nature in the execution of a procedures as opposed to interactive in the review of a procedure in which the user could revert to earlier revisions in their entirity for evaluation; an introduction section 63 as discussed in conection with FIG. 27; iii) a precautions and limitations sections 64 discussed below in connection with FIG. 28; a prerequisite section 65 as discussed below in connection with FIG. 29; iv) a performance section 66 discussed below in connection with FIGS. 30-32; v) a post performance section to allow for comments and feedback to be incorporated after completion of a procedure; and optionally vi) an appendix section which is largely a colllection of charts graphs, other materials that may be needed or desired to be associated with the procedure, however with computer-based platforms there is little need for a separate appendix section.

FIG. 27 illustrates an introduction section 63 of a technical procedure in the tool 60 and this section 63 largely mimics the formating of a paper based procedure and includes the purpose and scope of the foregoing procedure. Keeping the organization of the procedures similar to more familiar paper based procedures is advantageous. The introduction section 63 may further include a listing of charts, figures and other works associated with the procedure, each which would be clickable to allow the user to review the identified work.

FIG. 28 schematically illustrate the precautions and limitations sections 64 in the tool 60 associated with a procedure. On a paper procedure this section covers only precautions and limitations for the entire procedure i.e. global precautions. The platform includes all precautions and limititations in section 64, not just global precautions. In other words precautions and limitations associated with only select tasks or steps of a procedure are also listed in this section 64.

FIG. 29 illustrates a representative page of a prerequisites portion 65 of executing a procedure in tool 60 on the platform of the present invention. Here the operator or user is tasked with reviewing and optionally confirming the presence of all the tools equipment labor and managerial overview. The platform preferably seperates these into seperate conformation steps and/or into separate segments such as parts, tools, equipment and labor so the operator focuses on one step at a time, and as noted, the system may conform the operators review through a check off box to be filled by the operator. It is expected that the parts and tools and equipments will be preassembled or kitted for the operator and the platform will likely already advise if a part, equipment, tool or labor element is not present on site, this step is to allow the operator to review the elements for the procedure and to check the kitting has been performed correctly. In other words just because a part needed for the procedure is available onsite does not mean that part has been properly placed into the kit.

FIG. 30 is representative of a performance section 66 or execution section of the platform where the operater is shown the relevent steps of a procedure. Each step is preferably color coded to indicate the state of completion, with green being finished, white not started, blue being the current step and red being a step that cannot be performed at present due to a missing element (other than a preceding prerequisite step). The step will also turn red if the procedure is behind schedule. For example if after starting a procedure the necessary supervisory review moves off site (as indicated by badge swipes) needed to perform step 5 then it may be shown in red and updated in real time with this information. This representative image in FIG. 30 also shows the local precautions, that is those that are related to this step alone. Further, essentially anything necessary for this step will be shown in thumbnail format and the operator can select such thumbnails to review associated charts and diagrams, and other background information in full screen.

As the operator completes each step, the step may be manually checked off and the steps updated, and the platform thus holds the user's place in a procedure. This is known as placekeeping and becomes even more important in procedures that span considerable time.

Once the tasks here are fully complete the COMPLETE icon in the tool 60 can be clicked to move to the next task or set of steps. While the operator is on each step the platform is timing the length of time spent on completeing this step, and the timing is vital for scheduling and management and updating of future procedures. A timer for the total procedure may be shown

The platform will track if the procedure is being performed on schedule,or not, and if not the platform will know and track what steps are backing up the schedule. When there is a delay some of the scheduled work orders will turn red indicative of the delay. The platform provides for real time updating of forecasting of completion times for the scheduled procedures.

As shown in FIG. 30 the number of steps in the procedure, as well as the number of the step the operator is on, will be viewable to the user. The catagorization of the steps or tasks may be shown. Further the prerequisite steps may be shown to aid the user.

FIG. 30 also shows a Tool box icon which represents a quick link to the operator engagement features 120 such as introducing comments, pictures, codes, and moving around the procedures.

One optional aspect of the invention is the platforms potential uses of a repeat-back process—sometimes referred to as three-way communication. In three-way communication, the sender (conventionally a worker) first orally states his or her message to the receiver (typically another worker) clearly and concisely. For instance, the sender may direct the receiver to take an action, such as altering a piece of equipment that could impact the crew's safety. Within this aspect of the invention, the platform will serve as the sender. Next, the receiver acknowledges the communication by repeating the message to the sender. The receiver must restate any critical information exactly as it was stated by the sender. If the receiver does not understand the sender's message, he or she must ask for clarification. Finally, upon receipt of the proper indication from the receiver, the sender acknowledges the receiver's reply and verbally confirms to the receiver that the message is correct and properly understood. If the sender does not understand the receiver's reply, the sender must verbally indicate that the two parties do not understand each other, and then the repeat-back process must start again from the beginning. Thus in summary the platform acts as the sender in this context and will generally read an instruction and await it being read back when it will issue a confirmation. If the platform does not understand a response from the receiver the platform will make that known, such as by saying NO to make any miscommunication known to the worker.

FIG. 31 is also a schematic representation of a performance section 66 or execution section in tool 60 of the platform where the operater is given a procedure that has an IF-THEN alternative path procedure. The step asks the operator a question and the answer will vary the remaining procedure.

The platform may further incorporate procedures that have alternative paths not selected by the operator or operator inputs. Here the path direction is or may be automatically chosen by the platform based upon observed and measured parameters. Essentially, the platform will incorporate the calculations for alternative paths so the operator merely needs to inputs a desired parameter. As a representative example, in an inspection of vehicle, the procedure may direct the operator to input the tire tread depth and if an operator inputs 3/32″ or less the platform automatically moves to a replacement of the tire as part of the procedure whereas if the measured measurement is greater than 3/32″ the procedure can move to the next step. The platform is designed to only require the operator to perform measurements and allows the platform to automatically perform any required calculation.

It should also be mentioned that the subway map 110 allows for navigation in procedure by the operator to the desired steps.

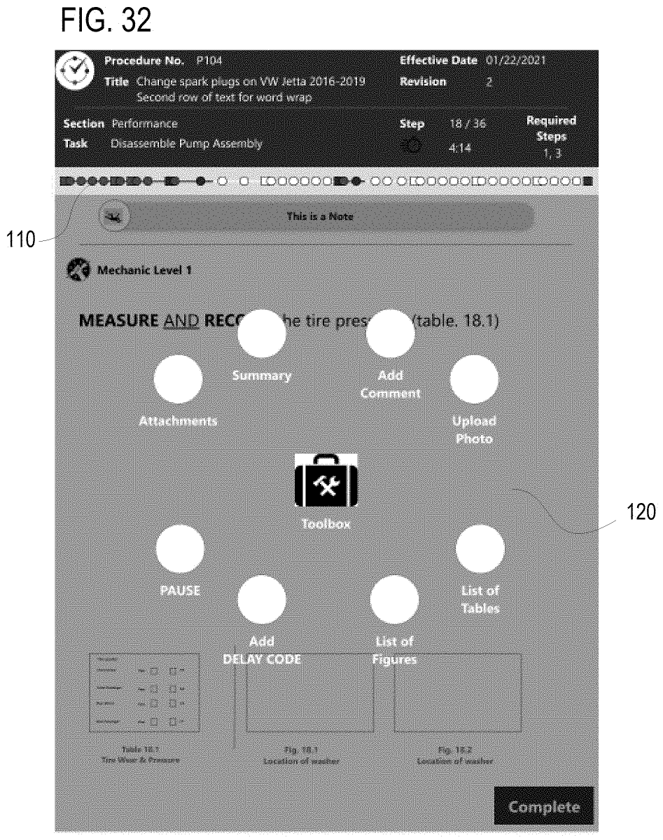

FIG. 32 shows the execution section 60 with the tool box 120 “opened” allowing the operator to add comments to the procedure, add images to the procedure, access any table or figure or attachments, see a summary of the procedure, enter a delay code for the step, or pause the step (such as for a lunch break or shift change). The delay codes and pause functions are helpful to maintain accurate time measurements of the individual steps.

Another feature of the platform is a Safety feature that would send out an alert to supervision that a step hasn't been completed in an expected amount of time. This delay could be indicative of a safety issue with a worker, e.g. fell off a ladder, sprayed with scalding water, etc. An alarm would sound on the device and send alerts to cell phones or other devices.

The platform of the present invention as described above provides an integrated, real time, digital, technical procedure platform comprising: a technical procedure scoping tool configured to assist in the process of evaluating and defining a given operation or process including an assembly or listing of required tools, equipment, parts, labor, authorizations, images, and existing hazards and all other constituents necessary for writing a technical procedure therefor; a technical procedure writing tool configured to assist in the process of drafting a written step by step technical procedure for a given operation or process; a technical procedure modifying tool configured for storing, revising, and updating technical procedures associated with changes to the procedures and/or constituents thereof, and maintaining a revision history of the technical procedure; a technical procedure scheduling tool configured for identifying the resources needed to complete a scheduled procedure, identifying a location of a scheduled procedure, setting a time for performing given scheduled technical procedures, including beginning times and estimated end times; a technical procedure executing tool configured to assist in the process of performing a given technical procedure; and a technical procedure managing tool configured for monitoring and evaluating the progress and completion of technical procedures.

Although the present invention has been described with particularity herein, the scope of the present invention is not limited to the specific embodiment disclosed. It will be apparent to those of ordinary skill in the art that various modifications may be made to the present invention without departing from the spirit and scope thereof.

What is claimed is:

1. A computer based, integrated, real time, digital, technical procedure platform comprising:
a technical procedure scoping tool configured to assist in the process of evaluating and defining a given operation or process including an assembly or listing of required tools, equipment, parts, labor, authorizations, images, and existing hazards and all other constituents necessary for writing a technical procedure therefor;
a technical procedure writing tool configured to assist in the process of drafting a written step by step technical procedure for a given operation or process;
a technical procedure modifying tool configured for storing, revising, and updating technical procedures associated with changes to the procedures and/or constituents thereof, and maintaining a revision history of the technical procedure;
a technical procedure scheduling tool configured for identifying the resources needed to complete a scheduled procedure, identifying a location of a scheduled procedure, setting a time for performing given scheduled technical procedures, including beginning times and estimated end times;
a technical procedure executing tool configured to assist in the process of performing a given technical procedure; and
a technical procedure managing tool configured for monitoring and evaluating the progress and completion of technical procedures.

2. The integrated, real time, digital, technical procedure platform according to claim 1 further comprising common libraries for at least three of parts, tools, equipment, labor, hold codes, delay codes, hazards and permits.

3. The integrated, real time, digital, technical procedure platform according to claim 2 wherein the platform automatically creates PERT charts any procedure.

4. The integrated, real time, digital, technical procedure platform according to claim 3 wherein each PERT charts shows the time between steps of a procedure and is color coded indicating progress.

5. The integrated, real time, digital, technical procedure platform according to claim 2 wherein the platform uses a repeat-back process in performance of procedures.

6. The integrated, real time, digital, technical procedure platform according to claim 2 wherein the platform provides that with the scheduling of the desired procedures the platform will identify the resources needed to complete each procedure, will identify the location of each procedure, will set a time for performing given technical procedures, including beginning times and estimated end times.

7. The integrated, real time, digital, technical procedure platform according to claim 2 wherein the platform illustrates a subway chart for each procedure performed on the platform, wherein the subway chart is a linear chart showing each of the steps of a given procedure along a continuous line.

8. The integrated, real time, digital, technical procedure platform according to claim 7 wherein each subway chart is color coded differentiating between completed, on time, not started, and late.

9. A computer based, integrated, real time, digital, technical procedure writing platform including common libraries for at least three of parts, tools, equipment, labor, hold codes, delay codes, hazards and permits.

10. The integrated, real time, digital, technical procedure platform according to claim 9 wherein the platform automatically creates PERT charts any procedure.

11. The integrated, real time, digital, technical procedure platform according to claim 10 wherein each PERT charts shows the time between steps of a procedure and is color coded indicating progress.

12. The integrated, real time, digital, technical procedure platform according to claim 9 wherein the platforms uses a repeat-back process in performance of procedures.

13. The integrated, real time, digital, technical procedure platform according to claim 9 wherein the platform provides that with the scheduling of the desired procedures the platform will identify the resources needed to complete each procedure, will identify the location of each procedure, will set a time for performing given technical procedures, including beginning times and estimated end times.

14. A computer based, integrated, real time, digital, technical procedure scoping and writing platform including:
a scoping tool configured to allow writers to evaluate and define a given operation or process including an assembly or listing of required tools, equipment, parts, labor, authorizations, images, and existing hazards and all other constituents necessary for writing a technical procedure therefor in a writing tool of the platform;
a technical procedure writing tool configured to assist in the process of drafting a written step by step technical procedure for a given operation or process; and
a technical procedure modifying tool configured for storing, revising, and updating technical procedures associated with changes to the procedures and/or constituents thereof, and maintaining a revision history of the technical procedure.

15. The integrated, real time, digital, technical procedure platform according to claim 14 further comprising common libraries for at least three of parts, tools, equipment, labor, hold codes, delay codes, hazards and permits.

16. The integrated, real time, digital, technical procedure platform according to claim 14 wherein the platform automatically creates PERT charts any procedure.

17. The integrated, real time, digital, technical procedure platform according to claim 16 wherein each PERT charts shows the time between steps of a procedure and is color coded indicating progress.

18. The integrated, real time, digital, technical procedure platform according to claim 14 wherein the platforms uses a repeat-back process in performance of procedures.

19. The integrated, real time, digital, technical procedure platform according to claim 14 wherein the platform provides that with the scheduling of the desired procedures the platform will identify the resources needed to complete each procedure, will identify the location of each procedure, will set a time for performing given technical procedures, including beginning times and estimated end times.

20. The integrated, real time, digital, technical procedure platform according to claim 14 wherein the platform illustrates a subway chart for each procedure performed on the platform, wherein the subway chart is a linear chart showing each of the steps of a given procedure along a continuous line.
